(19) United States
(12) Patent Application Publication
(10) Pub. No.: US 2015/0135178 A1
(43) Pub. Date: May 14, 2015

(54) MODIFYING VIRTUAL MACHINE COMMUNICATIONS

(71) Applicants: Anna Fischer, Bristol (GB); Aled Edwards, Charfield South Gloucestershire (GB); Patrick Goldsack, Bristol (GB)

(72) Inventors: Anna Fischer, Bristol (GB); Aled Edwards, Charfield South Gloucestershire (GB); Patrick Goldsack, Bristol (GB)

(21) Appl. No.: 14/381,453

(22) PCT Filed: Mar. 8, 2012
(86) PCT No.: PCT/US2012/028268

§ 371 Date: Aug. 27, 2014

(51) Int. Cl. G06F 9/455; H04L 29/12

(52) U.S. Cl. CPC G06F 9/45533; H04L 61/6022
USPC 718/1

(57) ABSTRACT

In one implementation, a host platform implemented on a computing device hosting one or more virtual machines determines that a communication generated by a virtual machine and intended for another virtual machine is to be transmitted to a network appliance. Consequently, the host platform modifies the communication generated by the virtual machine.

### BACKGROUND

A virtualized infrastructure, for example, provided by a cloud computing service, may include virtual networking resources to facilitate communications between different virtual machines implemented within the virtualized infrastructure. In some situations, it may be desirable to deploy a network appliance on a virtual network.

### BRIEF DESCRIPTION OF THE DRAWINGS

FIGS. 1A-1C are block diagrams of an example of a computing system on which virtualized infrastructures are provided.

FIG. 2 is a schematic diagram of an example of a virtual network.

FIG. 3 is a flow diagram illustrating an example of a process for transmitting a communication along a virtual network path.

FIGS. 4-6 are flow charts that illustrate examples of different processes for processing communications generated by virtual machines.

### DETAILED DESCRIPTION

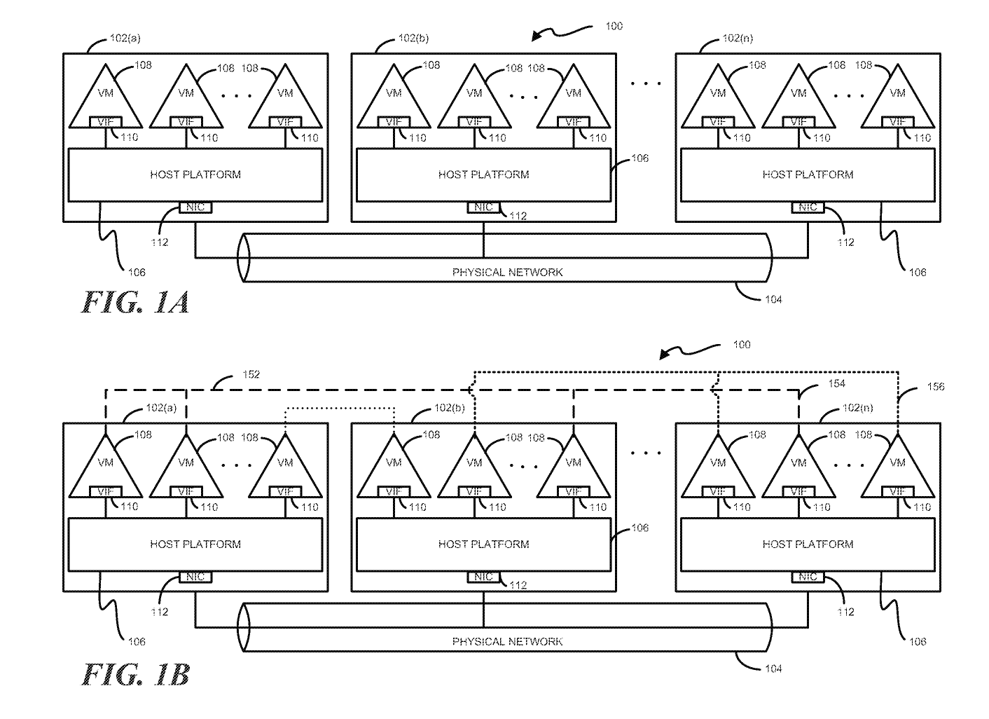

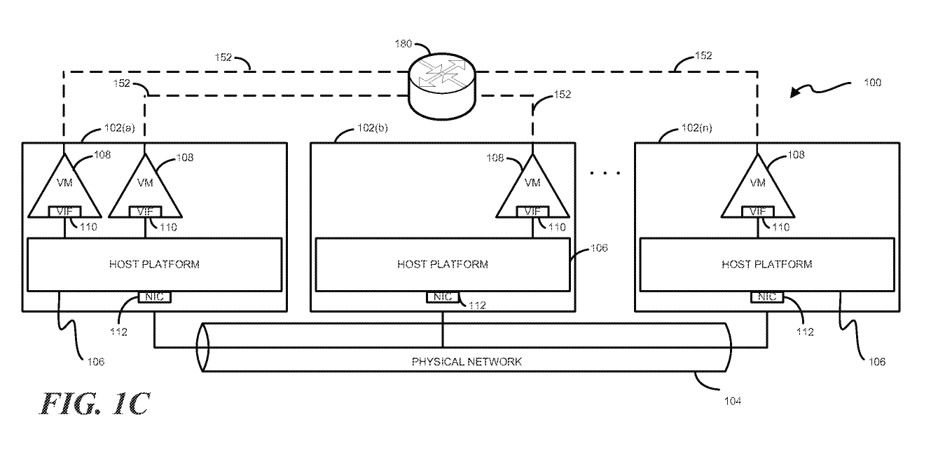

FIG. 1A is a block diagram of an example of a computing system 100 on which virtualized infrastructures are provided. Computing system 100 includes multiple physical computing devices 102(a)-102(n) (e.g., servers) communicatively coupled by a physical network 104.

Physical network 104 may provide direct or indirect communication links between physical computing devices 102. Examples of physical network 104 include local area networks (LANs) including wireless LANs (WLANs), wide area networks (WANs), the Internet, the World Wide Web, analog or digital wired and wireless telephone networks, radio, television, cable, satellite, and/or any other delivery mechanisms for carrying data, as well as combinations of any of the foregoing.

Each physical computing device 102 may include one or more processors for executing instructions stored in storage and/or received from one or more other electronic devices, for example over physical network 104. Furthermore, each physical computing device 102 may have internal or external storage components storing data and/or computer-readable instructions that, when executed by the one or more processors of the physical computing device 102 cause the physical computing device 102 to implement certain functionality.

As illustrated in FIG. 1A, each physical computing device 102 is configured to implement a host platform 106 and to host one or more virtual machines 108. In order to host one or more virtual machines 108, each physical computing device 102 may implement a hypervisor (not shown) and/or virtual machine manager (not shown). Such a hypervisor or virtual machine manager may be implemented as computer-readable instructions stored in storage components accessible to the physical computing device 102. When executed by the one or more processors of the physical computing device 102, these computer-readable instructions may cause the physical computing device to provide, among other functionality, the ability to control the allocation of resources of the physical computing device 102 (e.g., memory space) to the one or more virtual machines 108 hosted on the physical computing device 102, to manage the parallel execution of virtual machines 108 when multiple virtual machines are hosted on the physical computing device 102 concurrently, and/or to initiate context switching, as appropriate, during the cycling of the execution of virtual machines 108 when multiple virtual machines are hosted on the physical computing device. In some implementations, these computer-readable instructions may run directly on the hardware of the physical computing device 102. In other implementations, an operating system may run directly on the hardware of the physical computing device 102, and these computer-readable instructions may run within an environment provided by the operating system.

Each virtual machine 108 hosted on a physical computing device 102 may emulate an individual hardware device (e.g., a physical computing device such as a computer; a processing device such as a switch, router, firewall, and/or gateway; etc.) and provide a self-contained operating environment. As such, an individual virtual machine 108 hosted on a physical computing device 102 may run its own guest operating system on the physical computing device 102. Consequently, multiple different virtual machines 108 hosted on the physical computing device 102 may run their own guest operating systems, and such guest operating systems may be the same or different across the various different virtual machines 108 hosted on the physical computing device 102. Furthermore, a virtual machine 108 running its own guest operating system on physical computing device 102 also may execute one or more different applications. The hypervisor or virtual machine manager executing on each physical device 102 may dedicate specific portions of memory to each virtual machine hosted on the physical device 102 and regulate access to such dedicated portions of memory in an effort to prevent virtual machines 108 hosted on the physical computing device 102 from accessing the dedicated memory portion of another virtual machine 108 hosted on the physical computing device 102 (at least without authorization).

Host platforms 106 may be implemented as computer-readable instructions stored in storage components accessible to the physical computing devices 102 on which host platforms 106 are hosted. Among other features, the host platforms 106 implemented on the physical computing devices 102(a)-102(n) may make networking resources available to the virtual machines 108 hosted on the physical computing devices 102(a)-102(n), thereby enabling individual ones of the virtual machines 108 hosted by computing system 100 to exchange communications irrespective of whether the virtual machines 108 are hosted on the same or different physical computing devices 102. In some implementations, the host platforms 106 may provide hypervisor or virtual machine manager functionality in addition to making networking resources available. In alternative implementations, the host platforms 106 may not provide hypervisor or virtual machine manager functionality. For example, the host platforms 106 may be implemented as virtual machines that run on top of and/or are run by the hypervisors or virtual machine managers implemented on the physical computing devices 102. Additionally or alternatively, the host platforms 106 may be implemented as software layers that execute at hypervisor- or virtual machine manager-privilege level on the physical computing devices 102.

As illustrated in FIG. 1A, in some implementations, each virtual machine 108 may implement a virtual network interface (VIF) 110 that provides a networking interface to the host platform 106 that is implemented on the same physical computing device 102 as which the virtual machine. In addition, each host platform 106 may have access to a network interface card (NIC) of the physical computing device 102 on which it is implemented. In such implementations, an individual host platform 106 may be configured to receive a network packet (e.g., from a virtual machine 108 hosted on the same physical computing device 102 or from a virtual machine 108 hosted on a different physical computing device 102 over physical network 104) and distribute it appropriately.

For example, if the host platform 106 receives a packet destined for a virtual machine 108 executing on the same physical computing device 102 on which it is implemented, host platform 106 may dispatch the packet to the appropriate VIF 110 for the virtual machine 108 to which the packet is destined. Similarly, if the host platform 106 receives a packet (e.g., from a virtual machine 108 hosted on the same physical computing device 102 on which it is implemented) destined for a virtual machine 108 executing on a different physical computing device 102 than on which it is implemented, host platform 106 may forward the packet to a NIC 112 of the physical computing device 102 on which the host platform 106 is implemented for distribution across physical network 104 to the particular physical computing device 102 on which the destination virtual machine 108 is hosted.

In some implementations, the VIFs 110 of the virtual machines may mimic Ethernet devices and transmit outbound communications from their virtual machines 108 as Ethernet frames. In such implementations, the host platforms 106 may encapsulate outbound Ethernet frames in Internet Protocol (IP) packets (e.g., using the EtherIP protocol) before forwarding the packets to NICs 112 of the physical computing devices 102 on which they are implemented for distribution across physical network 104. Similarly, the host platforms 106 may decapsulate inbound IP packets into Ethernet frames (e.g., according to the EtherIP protocol) before dispatching the Ethernet frames to the VIFs 110 of the packet's virtual machines 108.

In some implementations, related virtual machines 108 hosted by computing system 100, even virtual machines 108 hosted by different physical computing devices 102, may be grouped into network segments that operate as virtual networks, each emulating a separate network fabric. For example, as illustrated in FIG. 1B, the virtual machines 108 hosted by computing system 100 may be segmented into three separate virtual networks 152, 154, and 156, each of which emulates its own separate network fabric. Such segmenting of related virtual machines 108 into a virtual network may enable enforcement of such security mechanisms across the virtual machines 108 of the network segment as isolation, confidentiality, integrity, and information flow control, among others. Various different motivations may inspire the segmenting of virtual machines 108 hosted by a computing system 100 into virtual networks. For example, in implementations where computing system 100 offers virtualized computing infrastructures to multiple different customers, the virtual machines 108 hosted by computing system 100 for a particular customer may be segmented into their own virtual network, thereby enabling enforcement of a common security policy across the virtual machines of the virtual network belonging to the particular customer.

In some cases, when a virtual network such as, for example, the virtual network 152 illustrated in FIG. 1B, is provided to emulate a network fabric connecting a particular group of related virtual machines 108 hosted by computing system 100, it may be desired to insert a network appliance into the virtual network 152. For example, referring to FIG. 1C, it may be desired to add a gateway 180 to virtual network 152 to process all (or some defined subset of all) network traffic on virtual network 152. Although a gateway is one example of a network appliance that may be deployed on a virtual network, many other types of network appliances also may be inserted into a virtual network. For example, firewalls, intrusion detection systems, routers, switches, IP telephony network appliances, unified communication solutions appliances, WAN optimization and application acceleration appliances, load balancing appliances, dynamic content caching appliances, secure sockets layer (SSL) acceleration appliances, application performance monitoring appliances, virtual private network (VPN)/IP security (IPsec) appliances, antimalware appliances, antispam appliances, and network management appliances, among others, are examples of other network appliances that may be deployed on a virtual network. In some implementations, such network appliances may be implemented as virtual machines hosted on the physical computing devices 102 of computing system 100. Additionally or alternatively, such network appliances may be implemented as standalone hardware devices communicatively coupled to physical network 104.

Techniques disclosed herein may enable the deployment of a network appliance on a virtual network, such as, for example, the deployment of gateway 180 on virtual network 152 described above in connection with FIG. 1C, without a reconfiguration of network-level information of the virtual machines on the virtual network and/or applications executing thereon. Additionally or alternatively, techniques disclosed herein may enable such network appliances to process traffic on the virtual network transparently to one or both of the source and destination endpoints for the network traffic such that one or both of the source and destination endpoints are unaware that the network traffic has been processed by the network appliance. A computing system that hosts such virtualized infrastructures and that employs such techniques to enable the deployment of network appliances on virtual networks without reconfiguring network-level information and the transparent processing of network traffic on virtual networks may be said to offer network processing as a service because network appliances may be deployed in a seamless and automated fashion and without noticeably interfering with network traffic.

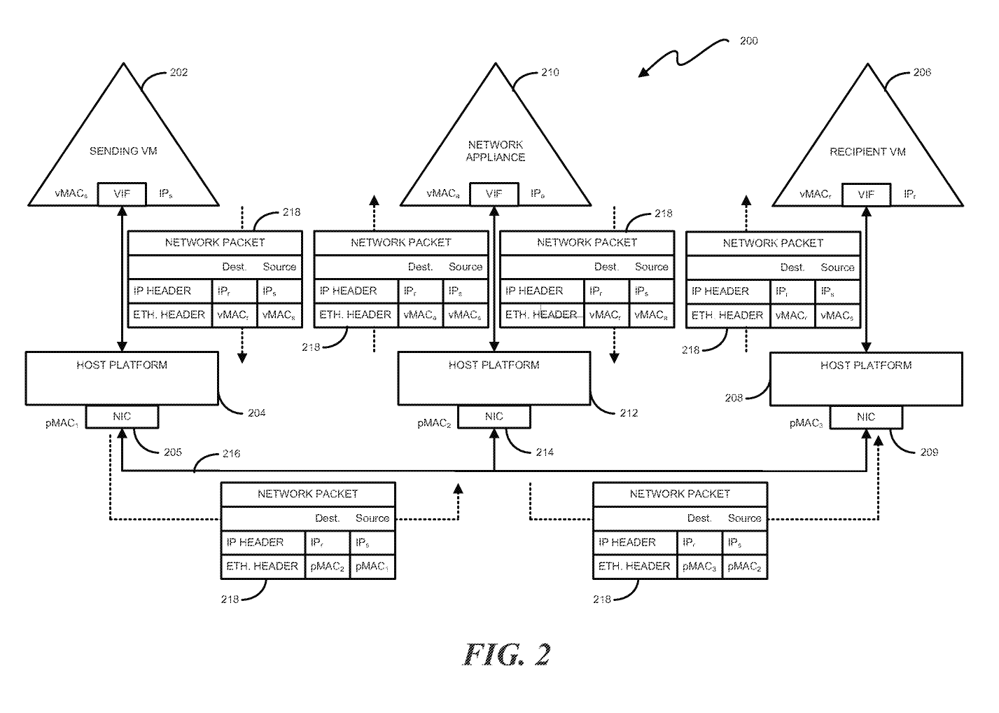

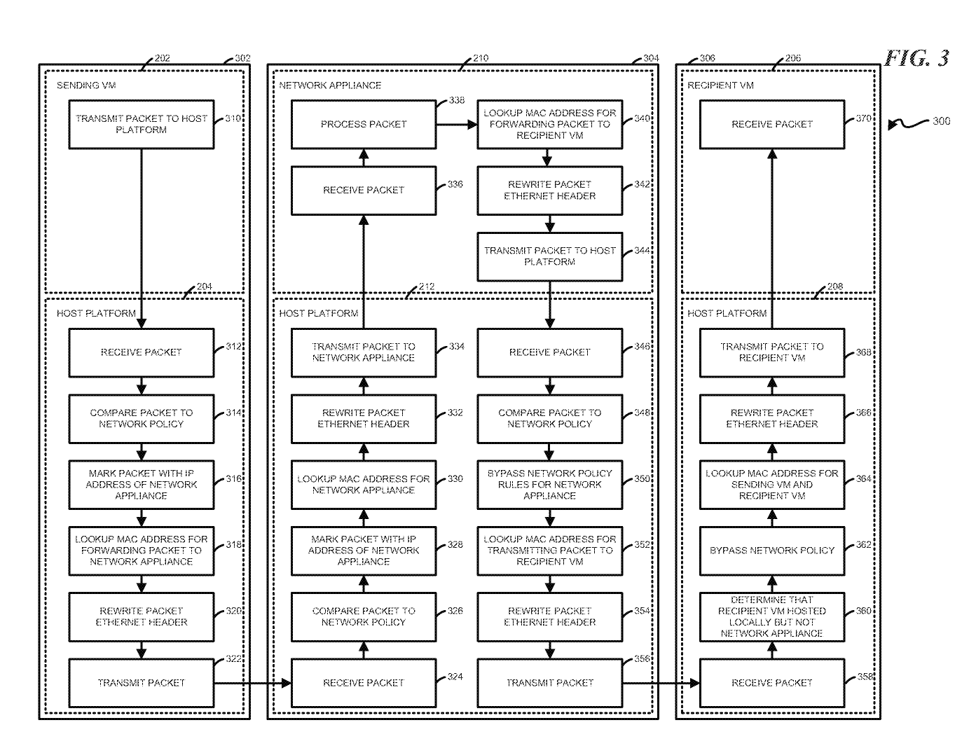

FIG. 2 is a schematic diagram of an example of a virtual network 200, and FIG. 3 is a flow diagram 300 illustrating an example of a process for transmitting a communication along a network path in a virtual network, such as, for example, virtual network 200 of FIG. 2.

As illustrated in FIG. 2, virtual network 200 includes a first virtual machine 202 and a corresponding first host platform 204 as well as a second virtual machine 206 and a corresponding second host platform 208. As described above in connection with FIGS. 1A-1C, first virtual machine 202 and host platform 204 are implemented on the same physical computing device (not shown), which has a NIC 205. Similarly, second virtual machine 206 and host platform 208 also are implemented on the same physical computing device (not shown), which has a NIC 209. In some implementations, first virtual machine 202 and second virtual machine may be implemented on the same physical computing device. In such implementations, first host platform 204 and second host platform 208 actually may represent the same host platform.

Virtual network 200 also includes a network appliance 210 and a corresponding third host platform 212. As illustrated in FIG. 2, network appliance 210 may be implemented as a virtual machine on the same physical computing device (not shown) as third host platform 212, and the physical computing device on which network appliance 210 and third host platform 212 are implemented may have a NIC 214. In some implementations, network appliance 210 may be implemented on a physical computing device that is different from the physical computing device(s) on which both first virtual machine 202 and second virtual machine 206 are implemented. In other implementations, network appliance 210 may be implemented on the same physical computing device as one or both of first virtual machine 202 and second virtual machine 206. In such implementations, third host platform 212 may represent the same host platform as one or both of first host platform 204 and second host platform 208.

As illustrated in FIG. 2, a physical network 216 communicatively connects the physical computing device on which first virtual machine 202 and first host platform 204 are implemented, the physical computing device on which network appliance 210 and third host platform 212 are implemented, and the physical computing device on which second virtual machine 206 and second host platform 208 are implemented. As further illustrated in FIG. 2, first virtual machine 202 has been assigned a virtual media access control (MAC) address, vMACₛ, and an IP address, IPₛ, related to its membership in virtual network 200. Similarly, second virtual machine 206 has been assigned a virtual MAC address, vMACᵣ, and an IP address, IP, related to its membership in virtual network 200, and network appliance 210 also has been assigned a virtual MAC address, vMACₐ, and an IP address, IPₐ, related to its membership in virtual network 200. In addition, the NIC 205 for the physical computing device on which first virtual machine 202 and first host platform 204 are implemented has been assigned a physical MAC address, pMAC₁, the NIC 214 for the physical computing device on which network appliance 210 and host platform 212 have been implemented has been assigned a physical MAC address, pMAC₂, and the NIC 209 for the physical computing device on which second virtual machine 206 and second host platform 208 are implemented has been assigned a physical MAC address pMAC₃. Although not illustrated in FIG. 2, first host platform 204, second host platform 208, and third host platform 212 each may store or otherwise have accessible to it a network policy that specifies one or more rules for processing (e.g., rerouting) traffic on virtual network 200 as well as one or more additional virtual networks provided by the computing system on which virtual network 200 is implemented.

The schematic diagram of FIG. 2 illustrates the path of a network packet 218 originally transmitted by an application executing on first virtual machine 202 to an application executing on second virtual machine 206. Because the network packet 218 is sent by an application executing on first virtual machine 202, first virtual machine 202 may be referred to as Sending Virtual Machine 202. Similarly, because the network packet 206 is received by an application executing on second virtual machine 206, second virtual machine 206 may be referred to as Recipient Virtual machine 206.

Referring again to FIG. 3, flow diagram 300 illustrates examples of processing operations performed on network packet 218 as it traverses virtual network 200 from Sending Virtual Machine 202 to Recipient Virtual Machine 206. Although not illustrated in FIG. 2, in FIG. 3, the physical computing device 302 on which Sending Virtual Machine 202 and first host platform 204 are implemented, the physical computing device 304 on which network appliance 210 and third host platform 212 are implemented, and the physical computing device 306 on which Recipient Virtual Machine 206 and second host platform 208 are implemented are illustrated.

As illustrated in FIGS. 2 and 3, when an application executing on Sending Virtual Machine 202 is ready to send a communication to an application executing on Recipient Virtual Machine 206, Sending Virtual Machine 202 composes network packet 218. In some implementations, the network packet 218 composed by Sending Virtual Machine 202 may be an Ethernet frame having an Ethernet header specifying the virtual MAC address vMACᵣ of the Recipient Virtual Machine 206 as the destination of the network packet 218 and the virtual MAC address vMACᵣ of the Sending Virtual Machine 202 as the source of the network packet 218. In addition, the payload of the Ethernet frame may include an IP packet having an IP header specifying the IP address IPᵣ of Recipient Virtual Machine 206 as the destination of the network packet 218 and the IP address IPₛ of the Sending Virtual Machine 202 as the source of the network packet 218. At 310, the Sending Virtual Machine 202 transmits the network packet 218 to the first host platform 204.

At 312, the first host platform 204 receives the network packet 218 from the Sending Virtual Machine 202. The first host platform 204 then compares the network packet 218 to the network policy at 314. As described above, the network policy may specify rules for processing traffic on virtual network 200 as well as one or more additional virtual networks provided by the computing system on which virtual network 200 is implemented.

For example, in some implementations, the network policy may specify that all traffic on virtual network 200 is to be routed through network appliance 210.

Alternatively, in other implementations, the network policy may specify that certain types of network traffic (but not necessarily all network traffic) on virtual network 206 are to be routed to network appliance 210. For example, the network policy may specify rules for rerouting network traffic to network appliance 210 that are based on network protocol. For instance, the network policy may specify that web traffic (e.g., HTTP and/or HTTPs traffic) is to be rerouted to network appliance 210. Additionally or alternatively, the network policy may specify that file downloads (e.g., FTP) and/or IP voice traffic should be rerouted to network appliance 210 (or a different network appliance). In this manner, different types of network traffic on virtual network 200 may be routed to different types of network appliances on virtual network 200.

In other implementations, the network policy may specify that all network traffic originating from one or more specific virtual machines (e.g., Sending Virtual Machine 202) is to be routed to network appliance 210. Additionally or alternatively, the network policy may specify that all network traffic destined for one or more specific virtual machines (e.g., Recipient Virtual Machine 206) is to be routed to network appliance 210. Alternatively, the network policy may specify that all traffic from one network destined for virtual network 200 is to be rerouted to network appliance 210.

Furthermore, in some implementations, only a subset of the network traffic that satisfies a rule specified by the network policy may actually be rerouted to network appliance 218. For example, only random samples of the network traffic that satisfies a rule specified by the network policy may actually be forwarded to network appliance 210. Alternatively, only some defined quantum of network traffic of a connection (e.g., every first packet of a new connection) that satisfies a rule specified by the network policy may actually be forwarded to network appliance 210.

As described above, in some implementations, the network packet may be an Ethernet frame and the payload of the Ethernet frame may include an IP packet. In such implementations, the first host platform 204 may determine the virtual network to which the network packet 218 corresponds, the source virtual machine of the network packet 218, and/or the destination virtual machine for the network packet 218 based on the source and/or destination IP addresses specified in the IP header of the IP packet. Additionally or alternatively, the first host platform 204 may determine the virtual network to which the network packet 218 corresponds, the source virtual machine of the network packet 218, and/or the destination virtual machine for the network packet 218 based on TCP/UDP port information or other information from higher level networking protocols specified in network packet 218.

In any event, as a consequence of comparing network packet 218 to the network policy, the first host platform 204 determines that, according to the network policy, network packet 218 is to be rerouted to network appliance 204. Therefore, at 316, the first host platform 204 marks the network packet 218 with the IP address IPₐ of the network appliance 210. For example, the IP address IPₐ of the network appliance 210 may be added to network packet 218 as a form of meta-data associated with the network packet 218 while the network packet 218 is processed by the first host platform 204 but that is disassociated (e.g., deleted or detached) from the network packet 218 after the network packet 218 is transmitted outside of the first host platform 204.

In addition to marking the network packet 218 with the IP address IPₐ of the network appliance 210, at 318, the first host platform 204 performs a lookup of a MAC address to use for forwarding network packet 218 to network appliance 210, for example, based on the IP address IPₐ of the network appliance 210 with which the network packet 218 has been marked.

Then, at 320, the first host platform 204 rewrites the Ethernet header of network packet 218. For example, as illustrated in FIG. 2, the first host platform 204 may perform a lookup of the physical MAC address pMAC₂ of the NIC 214 of the physical computing device 304 on which the network appliance 210 is implemented and rewrite the destination address of the Ethernet header of network packet 218 with pMAC₂. In addition, the first host platform 204 also may rewrite the source address of the Ethernet header of network packet 218 with the physical MAC address pMAC₁ of the NIC 205 of the physical computing device 302 on which Sending Virtual Machine 202 and the first host platform 204 are implemented. All the while, the first host platform 204 may leave the destination and source IP addresses specified in the IP header of network packet 218 unmodified. At 322, the first host platform 204 transmits the network packet 218 to NIC 205, which puts the network packet 218 onto the physical network 216. In some implementations, the network packet 218 may be an Ethernet frame, and, before transmitting the network packet 218 to NIC 205, the first host platform 204 may use the EtherIP protocol to encapsulate the Ethernet frame within an IP packet.

At 324, the network packet 218 is received, for example, via NIC 214, by the third host platform 212 implemented on the physical device 304 on which the network appliance 210 is implemented. In some implementations, the network packet 218 received by the third host platform 212 may be an IP packet within which an Ethernet frame is encapsulated. In such implementations, the third host platform may decapsulate the Ethernet frame from the IP packet upon receipt of the packet. Then, at 326, the third host platform 212 compares the received network packet 218 to the network policy, and, as a consequence, determines that the network packet 218 is to be processed by network appliance 210. In addition, comparing network packet 218 to the network policy also may return the IP address IPₐ of the network appliance 210. Therefore, at 328, the third host platform 212 marks the network packet 218 with the IP address IPₐ of the network appliance 210.

Then, at 330, the third host platform 212 performs a lookup of the virtual MAC address vMACₐ of the network appliance 210, for example, using the IP address IPₐ of the network appliance 210. Thereafter, at 332, the third host platform 212 rewrites the Ethernet header of network packet 218. For example, as illustrated in FIG. 2, the third host platform 212 may rewrite the destination MAC address of the Ethernet header of network packet 218 with vMACₐ. In addition, the third host platform 212 also may rewrite the source MAC address of the Ethernet header of network packet 218 with the virtual MAC address vMACₛ of the sending virtual machine 202. Host platform 212 may be able to rewrite the source MAC address of the Ethernet header of network packet 218 with the virtual MAC address vMACₛ of the sending virtual machine 202 by performing a lookup of the virtual MAC address of the sending virtual machine 202 based on the IP address for the Sending Virtual Machine 202 specified in the IP header of network packet 218. While the third host platform 212 rewrites the Ethernet header of network packet 218, the third host platform 212 may leave the destination and source IP addresses specified in the IP header of network packet 218 unmodified. Eventually, at 334, the third host platform 212 transmits the network packet to the network appliance 210.

At 336, the network appliance 210 receives the network packet 218 and, at 338, the network appliance 210 processes the received network packet 218. Depending on the type of network appliance 210, processing the network packet 218 may involve any of a number of different operations. For example, processing the network packet 218 may involve logging the network packet 218, inspecting the network packet 218, determining whether to drop the network packet 218, and/or modifying the network packet 218.

Whatever the case, after network appliance 210 passes the processed network packet 218, at 340, network appliance 210 performs a lookup of a MAC address to use for forwarding network packet 218 to Recipient Virtual Machine 206, for example, based on the IP address IPᵣ of the Recipient Virtual Machine specified in the IP header of network packet 218. Then, at 342, the network appliance 210 rewrites the Ethernet header of network packet 218. For example, as illustrated in FIG. 2, the network appliance 210 may perform a lookup of the virtual MAC address vMACᵣ of the Recipient Virtual Machine and rewrite the destination address of the Ethernet header of network packet 218 with vMACᵣ. In addition, the network appliance 210 also may rewrite the source address of the Ethernet header of network packet 218 with its own virtual MAC address vMACₐ. All the while, the network appliance 210 may leave the destination and source IP addresses specified in the IP header of network packet 218 unmodified. At 344, after rewriting the Ethernet header of network packet 218, the network appliance 210 transmits the network packet 218 to third host platform 212.

At 346, the third host platform 212 receives the network packet 218 from the network appliance 210. Then, at 348, the third host platform 212 compares the received network packet 218 to the network policy. Any network policy rules specifying the network appliance 210 as a destination to which the network packet 218 is to be rerouted are bypassed at 350. Otherwise, the network packet 218 may be infinitely looped back to the network appliance 210 and the network packet 218 may never arrive at its ultimate destination, Recipient Virtual Machine 206. In some implementations, network appliance 210 may have more than one network interface and/or more than one network address (e.g., more than one IP address). Consequently, network rules specifying any of the network interfaces and/or network addresses of the network appliance 210 as a destination to which the network packet 218 is to be rerouted may be bypassed at 350.

At 352, the third host platform 212 performs a lookup of a MAC address to use for forwarding network packet 218 to the Recipient Virtual Machine 206, for example, based on the IP address IPᵣ of the Recipient Virtual Machine specified as the destination address in the IP header of network packet 218. Then, at 354, the third host platform 212 rewrites the Ethernet header of network packet 218. For example, as illustrated in FIG. 2, the third host platform 212 may perform a lookup of the physical MAC address pMAC₃ of the NIC 209 of the physical computing device 306 on which the Recipient Virtual Machine 206 is implemented and rewrite the destination address of the Ethernet header of network packet 218 with pMAC₃. In addition, the third host platform 212 also may rewrite the source address of the Ethernet header of network packet 218 with the physical MAC address pMAC₂ of the NIC 214 of the physical computing device 304 on which the network appliance 210 and the third host platform 208 are implemented. All the while, the third host platform 212 may leave the destination and source IP addresses specified in the IP header of network packet 218 unmodified. At 356, the third host platform 212 transmits the network packet 218 to NIC 214, which puts the network packet 218 onto the physical network 216. As described above, in some implementations, network packet 218 may be an Ethernet frame. In such implementations, before transmitting the network packet 218 to NIC 214, the third host platform 212 may use the EtherIP protocol to encapsulate the Ethernet frame within an IP packet.

At 358, the network packet 218 is received, for example, via NIC 209, by the second host platform 209 implemented on the physical device 306 on which the Recipient Virtual Machine 206 is implemented. Upon receipt of the network packet 218, the second host platform 208 determines that the Recipient Virtual Machine 206 is hosted on the same physical computing device 306 as the second host platform 208. In addition, the second host platform 208 determines that the network appliance 210 to which the network policy specifies network packet 218 is to be rerouted is not hosted on the same physical computing device 306 as the second host platform 208. For example, the second host platform 208 may determine that the Recipient Virtual Machine 206 is hosted on the same physical computing device 306 as the second host platform 208 based on the destination IP addresses specified in the IP header of network packet 218. Additionally or alternatively, the second host platform 208 may determine that the network policy specifies that the network packet 218 is to be rerouted to network appliance 210 while also determining that network appliance is not implemented on the same physical computing device 306 as the second host platform 208, for example, based on the IP address for the network appliance 210 returned as a result of comparing the network packet 218 to the network policy. As a consequence of determining that the Recipient Virtual Machine 206 is implemented on the same physical computing device 306 as the second host platform 208 but that the network appliance 210 is not implemented on the same physical computing device 306 as the second host platform 208, the second host platform 208 may infer that the network packet 218 already has been processed by the network appliance 210. Therefore, at 362, any network policy rules specifying the network appliance 210 as a destination to which the network packet 218 is to be rerouted are bypassed.

Then, at 364, the second host platform 208 performs a lookup of the virtual MAC address vMACᵣ of the Recipient Virtual Machine 206, for example, using the IP address IPᵣ of the network appliance 210 specified as the destination address in the IP header of network packet 218, and the virtual MAC address vMACᵣ of the Sending Virtual Machine 202, for example, using the IP address IPₛ of the Sending Virtual Machine 202 specified as the source address in the IP header of network packet 218. Thereafter, at 366, the second host platform 208 rewrites the Ethernet header of network packet 218. For example, as illustrated in FIG. 2, the second host platform 208 may rewrite the destination MAC address of the Ethernet header of network packet 218 with vMACᵣ. In addition, the second host platform 208 also may rewrite the source MAC address of the Ethernet header of network packet 218 with the virtual MAC address vMACₛ of the sending virtual machine 202. While the second host platform 208 rewrites the Ethernet header of network packet 218, the second host platform 208 may leave the destination and source IP addresses specified in the IP header of network packet 218 unmodified. Eventually, at 368, the second host platform 208 transmits the network packet 218 to the Recipient Virtual Machine 206.

The Recipient Virtual Machine 206 receives the network packet 218 at 370. As illustrated in FIG. 2, as network packet 218 traverses virtual network 200 from Sending Virtual Machine 202 to Recipient Virtual Machine 206 the destination and source IP addresses specified in the IP header of network packet 218 are not changed. In addition, before transmitting the network packet 218 to Recipient Virtual Machine, the second host platform 208 rewrites the destination MAC address of the Ethernet header of network packet 218 with the virtual MAC address vMACᵣ of the Recipient Virtual Machine 206 and the source MAC address of the Ethernet header of the Ethernet frame of network packet 218 with the virtual MAC address vMACₛ of the Sending Virtual Machine 202. Consequently, the application executing on the Recipient Virtual Machine 206 that ultimately receives the network packet 218 may be unable to detect that the network packet 218 was processed by the network appliance 210.

As illustrated in FIGS. 2 and 3 and described above, the path that network packet 218 travels across virtual network 200 from Sending Virtual Machine 202 to network appliance 210 and ultimately Recipient Virtual Machine 206 does not traverse multiple virtual subnetworks. However, in some implementations, virtual network 200 may include multiple virtual subnetworks and the path that network packet 218 travels across virtual network 200 from Sending Virtual Machine 202 to network appliance 210 and ultimately Recipient Virtual Machine 206 may traverse two or more different virtual subnetworks. In such implementations, the Ethernet header rewriting described above and illustrated in connection with FIGS. 2 and 3 may be modified, for example, to account for the MAC addresses of network appliances, such as, for instance, gateways, that sit at the boundaries between the relevant virtual subnetworks of virtual network 200.

As also illustrated in FIGS. 2 and 3 and described above, the physical computing device 302 on which Sending Virtual Machine 202 and first host platform 204 are implemented, the physical computing device 304 on which network appliance 210 and third host platform 212 are implemented, and the physical computing device 306 on which Recipient Virtual Machine 206 and second host platform 208 are implemented all are different physical computing devices. However, in some implementations, two or all three of Sending Virtual Machine 202, network appliance 210, and Recipient Virtual Machine may be implemented on the same physical computing device. In such implementations, the Ethernet header rewriting described above and illustrated in connection with FIGS. 2 and 3 may be modified to account for the fact that the network packet 218 may need to make fewer trips on the physical network 216.

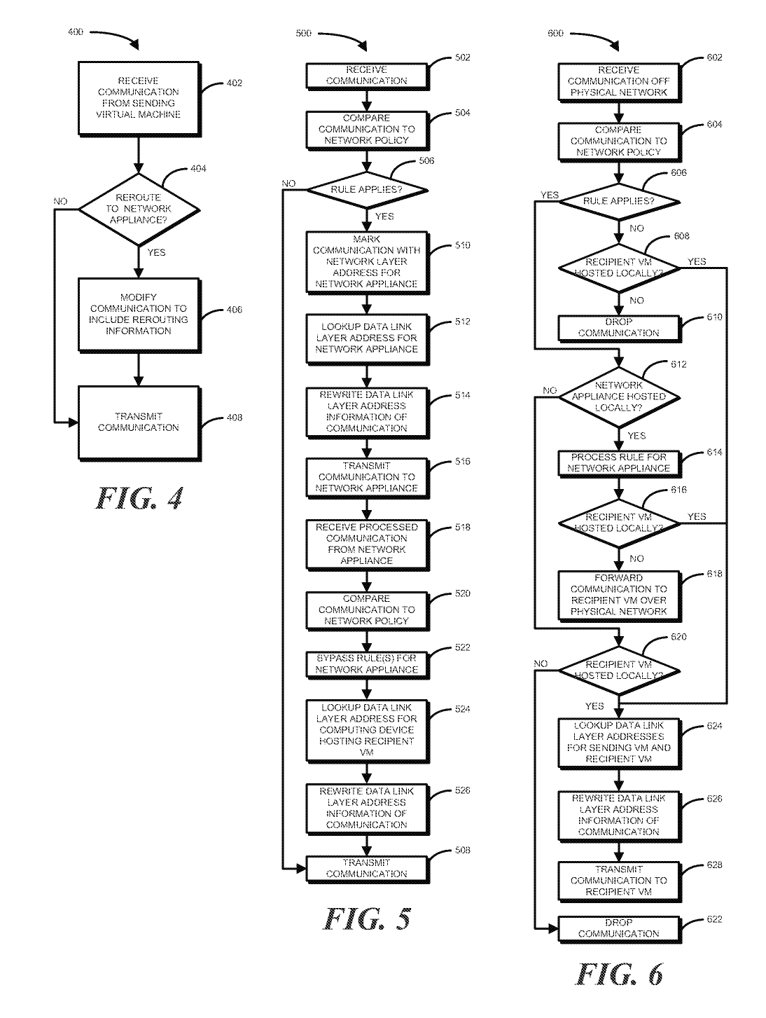

FIGS. 4-6 are flow charts that illustrate examples of different processes for processing communications generated by virtual machines. The processes illustrated in FIGS. 4-6 may be performed by host platforms implemented on physical computing devices, such as, for example, host platforms 106 illustrated in FIGS. 1A-1C and host platforms 204, 208, and 212 illustrated in FIGS. 2-3.

More particularly, FIG. 4 is a flow chart 400 that illustrates an example of a process for processing an outbound communication intended for a recipient virtual machine received by a host platform implemented on a physical computing device from a sending virtual machine implemented on the same physical computing device. As illustrated in FIG. 4, at 402, the host platform receives a communication from the sending virtual machine. For example, the host platform may receive an Ethernet frame from the sending virtual machine. The Ethernet frame may include an Ethernet header specifying a virtual MAC address for the sending virtual machine as the source of the Ethernet frame and a virtual MAC address for the recipient virtual machine for which the Ethernet frame is intended (or a MAC address for a gateway or other network device if the Ethernet frame is intended for a virtual machine on a different virtual subnetwork than the sending virtual machine). In addition, the payload of the Ethernet frame may include an IP packet having an IP header specifying an IP source address as an IP address assigned to the sending virtual machine and an IP destination address as an IP address assigned to the recipient virtual machine.

At 404, the host computing platform determines if the communication received from the sending virtual machine and intended for the recipient virtual machine is to be rerouted to a network appliance. In some implementations, the host computing platform may compare the received communication to a network policy that specifies rules for rerouting communications received by the host platform to different network appliances to determine if the received communication is to be rerouted to a network appliance. Continuing with the example introduced above where the communication received by the host platform is an Ethernet frame having a payload that includes an IP packet, the host platform may compare one or both of the source and destination IP addresses specified in the IP header of the IP packet to the network policy to determine if any rules specified within the network policy match the specified source and/or destination IP addresses. Additionally or alternatively, the host platform may compare TCP/UDP port information specified within the Ethernet frame to determine if any rules specified within the network policy match the specified TCP/UPD port information.

If the host platform determines, at 404, that the communication received from the sending virtual machine and intended for the recipient virtual machine is to be rerouted to a network appliance, the host machine modifies the communication to include rerouting information at 406. In some implementations, when the received communication is compared to the network policy and a determination is made that the received communication is subject to a network rule specified by the network policy, network address information for the network appliance, such as, for example, an IP address for the network appliance, may be returned to the host platform. The host platform then may use the returned network address for the network appliance to perform a lookup of rerouting information, which the host platform then uses to modify the communication. For example, in implementations where the communication received by the host platform is an Ethernet frame, an IP address for the network appliance may be returned to the host platform when comparison of the Ethernet frame to the network policy results in a determination that the Ethernet frame is subject to a network rule specified by the network policy. Thereafter, the host platform may use the IP address returned for the network appliance to perform a lookup of a MAC address to use to forward the communication to the network appliance. Then the host platform may rewrite the destination Ethernet address specified in the Ethernet header of the Ethernet frame with the MAC address to be used to forward the communication to the network appliance.

Referring again to FIG. 4, after modifying the communication received from the sending virtual machine to include rerouting information for the network appliance, the host platform then transmits the communication.

Alternatively, in the event that the host platform determines, at 404, that the communication is not to be rerouted to a network appliance, the host platform proceeds to 408 and transmits the communication without modifying the communication to include rerouting information.

FIG. 5 is a flow chart 500 that illustrates an example of a process for processing a communication that is received by a host platform. As illustrated in FIG. 5, the host platform receives a communication at 502. In some cases (e.g., if the host platform receives the communication over the physical network), the communication may be an IP packet within which is encapsulated an Ethernet frame that was originally generated by a sending virtual machine and intended for a recipient virtual machine. In such cases, the host platform may decapsulate the Ethernet frame from the IP packet upon receipt of the communication. In other cases (e.g., if the host platform receives the communication from a virtual machine implemented on the same physical computing device as the host platform), the communication may be an Ethernet frame generated by a sending virtual machine and intended for a recipient virtual machine. In either of these cases, the payload of the Ethernet frame itself may include an IP packet having an IP header that specifies an IP address for the sending virtual machine as the source of the communication and that specifies an IP address for the recipient virtual machine as the destination of the communication.

At 504, the host platform compares the received communication to a network policy that specifies rules for rerouting different communications received by the host platform. Then, at 506, based on having compared the received communication to the network policy, the host determines if any rules specified in the network policy apply to the received communication.

If no rules specified in the network policy apply to the communication, then, at 508, the host platform simply transmits the communication, for example, according to routing information specified within the communication.

Alternatively, if the host platform determines that a rule specified in the network policy applies to the communication, and, therefore, the communication is to be rerouted to a network appliance implemented in the same physical computing device as the host platform, the host platform marks the communication with a network layer address for the network appliance at 510. For example, if the communication is an Ethernet frame, host platform may mark the Ethernet frame with an IP address for the network appliance.

Then, at 512, the host platform performs a lookup of a data link layer address for the network appliance. In some implementations, the host platform may use the network layer address for the network appliance with which the communication has been marked to perform the lookup of the data link layer address for the network appliance. For example, if the communication is an Ethernet frame that has been marked with an IP address for the network appliance, the host platform may use the IP address for the network appliance with which the Ethernet frame has been marked to perform a lookup of a virtual MAC address for the network appliance. At 514, the host platform rewrites existing data link layer address information of the communication with the identified data link layer address information for the network appliance. For example, if the communication is an Ethernet frame, the host platform may rewrite the destination MAC address in the Ethernet header of the Ethernet frame with a virtual MAC address identified as corresponding to the network appliance.

After rewriting the existing data link layer address information of the communication with the identified data link layer address information for the network appliance, the host platform transmits the communication to the network appliance at 518. Thereafter, at 518, the host platform ultimately receives the processed communication back from the network appliance. Upon receipt of the processed communication from the network appliance, the host platform compares the processed communication to the network policy at 520. As a result of comparing the processed communication to the network policy, the host platform determines to bypass any rule(s) in the network policy specifying that the communication is to be rerouted to the network appliance, because the network appliance already has processed the communication and, otherwise, the communication may end up being infinitely looped back to the network appliance.

At 524, the host platform performs a lookup of a data link layer address for the physical computing device that hosts the recipient virtual machine for which the communication is destined. For example, if the communication is an Ethernet frame having a payload that includes an IP packet that specifies an IP address for the sending virtual machine as the source of the communication and that specifies an IP address for the recipient virtual machine as the destination of the communication, the host platform may use the IP address of the recipient virtual machine specified in the IP header of the IP packet to perform a lookup of the MAC address for the physical computing device on which the recipient virtual machine is implemented.

After identifying a data link layer address for the physical computing device on which the recipient virtual machine is implemented, the host platform rewrites existing data link layer address information of the communication with the identified data link layer address information for the physical computing device on which the recipient virtual machine is implemented at 526. For example, if the communication is an Ethernet frame, the host platform may rewrite the destination MAC address in the Ethernet header of the Ethernet frame with the MAC address identified for the physical computing device on which the recipient virtual machine. After rewriting the existing data link layer address information of the communication with the identified data link layer address information for the physical computing device on which the recipient virtual machine is implemented, the host platform transmits the communication to the physical computing device on which the recipient virtual machine is implemented at 508.

FIG. 6 is a flow chart 600 that illustrates an example of a process for processing a communication that is received by a host platform from the physical network. As illustrated in FIG. 6, the host platform receives a communication off the physical network at 602. In some implementations, the communication may be an IP packet within which is encapsulated an Ethernet frame that was originally generated by a sending virtual machine and that is intended for a recipient virtual machine. In such implementations, the host platform may decapsulate the Ethernet frame from the IP packet upon receipt of the communication. The payload of the decapsulated Ethernet frame itself may include an IP packet having an IP header that specifies an IP address for the sending virtual machine as the source of the communication and that specifies an IP address for the recipient virtual machine as the destination of the communication.

At 604, the host platform compares the received communication to a network policy that specifies rules for rerouting different communications received by the host platform. Then, at 606, based on having compared the received communication to the network policy, the host determines if any rules specified in the network policy apply to the received communication.

If the host platform determines that no rule in the network policy applies to the communication, the host platform proceeds to 608, where the host platform determines if the recipient virtual machine for which the communication is destined is hosted locally on the same physical computing device as the host platform. If the host platform determines that the recipient virtual machine is not hosted locally on the same physical computing device as the host platform, the host platform drops the communication at 610. Alternatively, if the host platform determines that the recipient virtual machine is hosted locally on the same physical computing device as host platform, the host platform proceeds to 624, which is described in greater detail below.

Returning again to 606, if, instead of determining that no rule in the network policy applies to the communication, the host platform determines that a rule in the network policy specifies that the communication is to be rerouted to a network appliance, the host platform proceeds to 612, where the host platform determines if the network appliance to which the rule specifies the communication is to be rerouted is hosted locally on the same physical computing device as the host platform. If the host platform determines that the network appliance is hosted locally on the same physical computing device as the host platform, at 614, the host platform processes the rule for the network appliance. For example, the host platform may transmit the communication to the network appliance.

Then, at 616, after the processed communication has been passed back to the host platform by the network appliance, the host platform determines if the recipient virtual machine to which the communication is destined is hosted locally on the same physical computing device as the host platform. If the recipient virtual machine is hosted locally on the same physical computing device as the host platform, the host platform proceeds to 624, which is described in greater detail below. Alternatively, if the recipient virtual machine is not hosted locally on the same physical computing device, the host platform forwards the communication to the recipient virtual machine over the physical network.

Returning again to 612, if the host platform determines that the network appliance is not hosted locally on the same physical computing device as the host platform, the host platform proceeds to 620, where the host platform determines if the recipient virtual machine is hosted locally on the same physical computing device as the host platform. If the host platform determines that the recipient virtual machine is not hosted on the same physical computing device as the host platform, the host platform drops the communication at 622. Alternatively, if the host platform determines at 620 that the recipient virtual machine is hosted on the same physical computing device as the host platform, the process proceeds to 624.

At 624, the host platform performs a lookup of data link addresses for the sending virtual machine and the recipient virtual machine. For example, if the communication is an Ethernet frame having a payload that includes an IP packet that specifies an IP address for the sending virtual machine as the source of the communication and that specifies an IP address for the recipient virtual machine as the destination of the communication, the host platform may use the IP addresses of the sending and recipient virtual machines specified in the IP header of the IP packet to perform a lookup of the MAC addresses for the sending and recipient virtual machines.

After identifying data link layer addresses for the sending and recipient virtual machines, the host platform rewrites existing data link layer address information of the communication with the identified data link layer addresses for the sending and recipient virtual machines at 626. For example, if the communication is an Ethernet frame, the host platform may rewrite the source MAC address in the Ethernet header of the Ethernet frame with the MAC address identified for the sending virtual machine and the host platform may rewrite the destination MAC address in the Ethernet header of the Ethernet frame with the MAC address identified for the recipient virtual machine. After rewriting the existing data link layer address information of the communication with the identified data link layer address information for the sending and recipient virtual machines, the host platform transmits the communication to the recipient virtual machine at 628.

A number of methods, techniques, systems, and apparatuses have been described. The described methods, techniques, systems, and apparatuses may be implemented in digital electronic circuitry or computer hardware, for example, by executing instructions stored in computer-readable storage media.

Apparatuses implementing these techniques may include appropriate input and output devices, a computer processor, and/or a tangible computer-readable storage medium storing instructions for execution by a processor.

A process implementing techniques disclosed herein may be performed by a processor executing instructions stored on a tangible computer-readable storage medium for performing desired functions by operating on input data and generating appropriate output. Suitable processors include, by way of example, both general and special purpose microprocessors. Suitable computer-readable storage devices for storing executable instructions include all forms of non-volatile memory, including, by way of example, semiconductor memory devices, such as Erasable Programmable Read-Only Memory (EPROM), Electrically Erasable Programmable Read-Only Memory (EEPROM), and flash memory devices; magnetic disks such as fixed, floppy, and removable disks; other magnetic media including tape; and optical media such as Compact Discs (CDs) or Digital Video Disks (DVDs). Any of the foregoing may be supplemented by, or incorporated in, specially designed application-specific integrated circuits (ASICs).

Although the operations of the disclosed techniques may be described herein as being performed in a certain order and/or in certain combinations, in some implementations, individual operations may be rearranged in a different order, combined with other operations described herein, and/or eliminated, and the desired results still may be achieved. Similarly, components in the disclosed systems may be combined in a different manner and/or replaced or supplemented by other components and the desired results still may be achieved.

What is claimed is:

1. A system comprising:
a first computing device to:
host a first virtual machine, and
implement a first host platform to:
determine that a communication generated by the first virtual machine that includes an indication that it is intended for a second virtual machine is to be transmitted to a network appliance, and
as a consequence of determining that the communication generated by the first virtual machine is to be transmitted to the network appliance, modify the communication generated by the first virtual machine to include an indication that a computing device that hosts the network appliance is the destination for the communication generated by the first virtual machine; and
a second computing device communicatively coupled to the first computing device to:
host the second virtual machine, and
implement a second host platform to:
determine that a communication received at the second computing device that includes an indication that it is intended for the second virtual machine and an indication that it was transmitted by the computing device that hosts the network appliance originated from the first virtual machine, and
as a consequence of determining that the communication received at the second computing device originated from the first virtual machine, overwrite the indication in the communication received at the second computing device that it is was transmitted by the computing device that hosts the network appliance with an indication that it originated from the first virtual machine.

2. The system of claim 1 wherein the first host platform is configured to determine that a communication generated by the first virtual machine that includes an indication that it is intended for a second virtual machine is to be transmitted to a network appliance by:
comparing the communication generated by the first virtual machine to a network policy, and
based on a result of comparing the communication generated by the first virtual machine to the network policy, determine that the communication is to be transmitted to the network appliance.

3. The system of claim 1 wherein:
the first host platform is configured to:
determine that the communication generated by the first virtual machine is to be transmitted to the network appliance based on a network layer address included in the communication generated by the first virtual machine, and
modify the communication generated by the first virtual machine to include an indication that the computing device that hosts the network appliance is the destination for the communication by overwriting a data link layer destination address included in the communication generated by the first virtual machine with a data link layer destination address for the computing device that hosts the network appliance; and
the second host platform is configured to:
determine that the communication received at the second computing device originated from the first virtual machine based on a network layer source address included in the communication received at the second computing device, and
overwrite the indication in the communication received at the second computing device that it is was transmitted by the computing device that hosts the network appliance with an indication that it originated from the first virtual machine by overwriting a data link layer source address included in the communication received at the second computing device with a data link layer address for the first virtual machine.

4. The system of claim 1 wherein:
the communication generated by the first virtual machine is an Ethernet frame that includes:
an Ethernet header having a source Media Access Control (MAC) address for the first virtual machine and a destination MAC address for the second virtual machine,
an IP packet having an IP header having a source IP address for the first virtual machine and a destination IP address for the second virtual machine, the source IP address for the first virtual machine being the indication that the communication generated by the first virtual machine is intended for the second virtual machine; and
the first host platform is configured to:
determine that the communication generated by the first virtual machine is to be transmitted to the network appliance based on the IP header of the communication generated by the first virtual machine, and
modify the communication generated by the first virtual machine to include an indication that the computing device that hosts the network appliance is the destination for the communication by overwriting the MAC address for the second virtual machine with a MAC address for the computing device that hosts the network appliance as the destination MAC address in the Ethernet header of the communication generated by the first virtual machine;
the communication received at the second computing device includes an Ethernet frame having:
an Ethernet header having a source MAC address for the computing device that hosts the network appliance and a destination MAC address for the second computing device, and
an IP packet having an IP header having a source IP address for the first virtual machine and a destination IP address for the second virtual machine, the destination IP address for the second virtual machine being the indication that the communication received at the second computing device is intended for the second virtual machine; and
and
the second host platform is configured to:
determine that the communication received at the second computing device originated from the first virtual machine based on the source IP address for the first virtual machine in the IP header of the communication received at the second computing device, and
overwrite the indication in the communication received at the second computing device that it is was transmitted by the computing device that hosts the network appliance with an indication that it originated from the first virtual machine by overwriting the MAC address for the computing device that hosts the network appliance with the MAC address for the first virtual machine as the source MAC address in the Ethernet header of the communication received at the second computing device.

5. The system of claim 4 wherein the first host platform is configured to determine that the communication generated by the first virtual machine is to be transmitted to the network appliance based on the destination IP address for the second virtual machine in the IP header of the communication generated by the first virtual machine.

6. The system of claim 4 wherein the first host platform is configured to determine that the communication generated by the first virtual machine is to be transmitted to the network appliance based on the source IP address for the first virtual machine in the IP header of the communication generated by the first virtual machine.

7. The system of claim 1 further comprising the computing device that hosts the network appliance, the computing device that hosts the network appliance being configured to:
host the network appliance, and
implement a third host platform to:
determine that a communication received at the computing device that hosts the network appliance and that includes an indication that it is intended for the second virtual machine and an indication that it originated from the first virtual machine is to be passed to the network appliance,
as a consequence of determining that the communication received at the computing device that hosts the network appliance is to be passed to the network appliance, pass the communication received at the computing device that hosts the network appliance to the network appliance,
determine that a communication passed by the network appliance to the third host platform includes an indication that it is intended for the second virtual machine, and
as a consequence of determining that the communication passed by the network appliance to the third host platform includes an indication that it is intended for the second virtual machine, modify the communication passed by the network appliance to the third host platform to include an indication that the second computing device is the destination for the communication.

8. The system of claim 1 wherein:
the first computing device is further configured to host a third virtual machine; and
the first host platform is further configured to:
determine that a different communication generated by the third virtual machine that includes an indication that it is intended for a fourth virtual machine is to be transmitted to a different network appliance, and
as a consequence of determining that the communication generated by the third virtual machine is to be transmitted to the different network appliance, modify the communication generated by the third virtual machine to include an indication that a computing device that hosts the different network appliance is the destination for the communication generated by the third virtual machine.

9. A method comprising:
receiving, at a host platform executing on a computing device, a network packet including an IP packet generated by a sender virtual machine executing on the computing device, the Network packet being intended for a recipient virtual machine;
comparing, using the host platform executing on the computing device, information in an IP header of the Network packet to a network policy;
based on a result of comparing the information in the IP header to the network policy, determining, using the host platform executing on the computing device, that the Network packet is to be transmitted to a network appliance;
as a consequence of determining that the Network packet is to be transmitted to the network appliance, marking, using the host platform executing on the computing device, the Network packet with an IP address for the network appliance;
identifying, using the host platform executing on the computing device, a Media Access Control (MAC) address for a computing device corresponding to the IP address for the network appliance; and
rewriting, using the host platform executing on the computing device, a destination address of an Ethernet header of the Network packet specifying a MAC address for the recipient virtual machine with the MAC address identified as corresponding to the IP address for the network appliance.

10. The method of claim 9 further comprising transmitting the Network packet from the computing device after rewriting the destination address of the Ethernet header of the Network packet specifying the MAC address for the recipient virtual machine with the MAC address identified as corresponding to the IP address for the network appliance.

11. The method of claim 10 wherein:
the network appliance is implemented as another virtual machine executing on another computing device;
identifying a MAC address for a computing device corresponding to the IP address for the network appliance includes identifying a MAC address for the other computing device on which the virtual machine implementing the network appliance is executing; and
rewriting the destination address of the Ethernet header of the Network packet specifying the MAC address for the recipient virtual machine with the MAC address identified as corresponding to the IP address for the network appliance includes rewriting the destination address of the Ethernet header of the Network packet specifying the MAC address for the recipient virtual machine with the MAC address identified for the other computing device on which the virtual machine implementing the network appliance is executing; and
the method further comprises:
after transmitting the Network packet from the computing device, receiving, at another host platform executing on the other computing device, the Network packet having the destination address in the Ethernet header specifying the MAC address for the other computing device on which the virtual machine implementing the network appliance is executing,
comparing, using the other host platform executing on the other computing device, information in the IP header of the Network packet to another network policy,
based on a result of comparing the information in the IP header to the other network policy, determining, using the other host platform executing on the other computing device, that the Network packet is to be transmitted to the network appliance,
as a consequence of determining, using the other host platform executing on the other computing device, that the Network packet is to be transmitted to the network appliance, marking, using the host platform executing on the computing device, the Network packet with an IP address for the network appliance,
identifying, using the other host platform executing on the other computing device, a MAC address for the network appliance,
rewriting, using the other host platform executing on the other computing device, the destination address of the Ethernet header of the Network packet specifying the MAC address for the other computing device with the MAC address identified for the network appliance,
passing the Network packet to the network appliance after rewriting the destination address of the Ethernet header of the Network packet to the MAC address identified for the network appliance,
receiving, at the other host platform executing on the other computing device and from the network appliance, the Network packet after processing of the Network packet by the network appliance, a source address of the Ethernet header of the processed Network packet specifying the MAC address for the network appliance and the destination address of the Ethernet header of the processed Network packet specifying a MAC address for the recipient virtual machine,
responsive to receiving the processed Network packet, identifying, using the other host platform executing on the other computing device, a MAC address for a different computing device hosting the recipient virtual machine,
rewriting, using the other host platform executing on the other computing device, the destination address of the Ethernet header specifying the MAC address for the recipient virtual machine with the MAC address identified for the different computing device hosting the recipient virtual machine,
transmitting the Network packet from the other computing device after rewriting the destination address of the Ethernet header of the Network packet specifying the MAC address for the recipient virtual machine with the MAC address identified for the different computing device hosting the recipient virtual machine,
after transmitting the Network packet from the other computing device, receiving, at a different host platform executing on the different computing device, the Network packet having the destination address in the Ethernet header specifying the MAC address for the different computing device hosting the recipient virtual machine, and
rewriting, using the different host platform executing on the different computing device, the destination address of the Ethernet header of the Network packet specifying the MAC address for the different computing device with the MAC address for the recipient virtual machine.

12. The method of claim 11 wherein:
the IP header of the Network packet includes an IP header source address specifying an IP address of the sender virtual machine and an IP header destination address specifying an IP address of the recipient virtual machine;
rewriting the destination address of the Ethernet header of the Network packet specifying the MAC address for the recipient virtual machine with the MAC address identified for the other computing device on which the virtual machine implementing the network appliance is executing includes rewriting the destination address of the Ethernet header of the Network packet specifying the MAC address for the recipient virtual machine with the MAC address identified for the other computing device on which the virtual machine implementing the network appliance is executing while preserving the IP header source address as specifying the IP address of the sender virtual machine and the IP header destination address as specifying the IP address of the recipient virtual machine;
rewriting, using the other host platform executing on the other computing device, the destination address of the Ethernet header of the Network packet specifying the MAC address for the other computing device with the MAC address identified for the network appliance includes rewriting, using the other host platform executing on the other computing device, the destination address of the Ethernet header of the Network packet specifying the MAC address for the other computing device with the MAC address identified for the network appliance while preserving the IP header source address as specifying the IP address of the sender virtual machine and the IP header destination address as specifying the IP address of the recipient virtual machine;
rewriting, using the other host platform executing on the other computing device, the destination address of the Ethernet header specifying the MAC address for the recipient virtual machine with the MAC address identified for the different computing device hosting the recipient virtual machine includes rewriting, using the other host platform executing on the other computing device, the destination address of the Ethernet header specifying the MAC address for the recipient virtual machine with the MAC address identified for the different computing device hosting the recipient virtual machine while preserving the IP header source address as specifying the IP address of the sender virtual machine and the IP header destination address as specifying the IP address of the recipient virtual machine; and
rewriting, using the different host platform executing on the different computing device, the destination address of the Ethernet header of the Network packet specifying the MAC address for the different computing device with the MAC address for the recipient virtual machine includes rewriting, using the different host platform executing on the different computing device, the destination address of the Ethernet header of the Network packet specifying the MAC address for the different computing device with the MAC address for the recipient virtual machine while preserving the IP header source address as specifying the IP address of the sender virtual machine and the IP header destination address as specifying the IP address of the recipient virtual machine.

13. The method of claim 9 wherein:
the network appliance is implemented as a virtual machine executing on a different computing device;
identifying a MAC address for a computing device corresponding to the IP address for the network appliance includes identifying a MAC address for the different computing device on which the virtual machine implementing the network appliance is executing; and
rewriting the destination address of the Ethernet header of the Network packet specifying the MAC address for the recipient virtual machine with the MAC address identified as corresponding to the IP address for the network appliance includes rewriting the destination address of the Ethernet header of the Network packet specifying the MAC address for the recipient virtual machine with the MAC address identified for the different computing device on which the virtual machine implementing the network appliance is executing.

14. The method of claim 9 wherein:
the network appliance is a standalone, physical network appliance having its own MAC address;
identifying a MAC address for a computing device corresponding to the IP address for the network appliance includes identifying the MAC address for the standalone, physical network appliance; and
rewriting the destination address of the Ethernet header of the Network packet specifying the MAC address for the recipient virtual machine with the MAC address identified as corresponding to the IP address for the network appliance includes rewriting the destination address of the Ethernet header of the Network packet specifying the MAC address for the recipient virtual machine with the MAC address identified for the standalone, physical network appliance.

15. A non-transitory, computer-readable storage medium storing instructions that, when executed by a host computer hosting a virtual machine, cause the computer to implement a host platform to:
receive a communication generated by the virtual machine hosted by the computing device that includes:
first layer address information identifying the virtual machine hosted by the computing device as the source of the communication and a recipient virtual machine as the destination for the communication, and
second layer address information identifying the virtual machine hosted by the computing device as the source of the communication and the recipient virtual machine as the destination for the communication;
determine that the communication is to be transmitted to a network appliance; and
as a consequence of determining that the communication is to be transmitted to a network appliance, rewrite the second layer address information identifying the recipient virtual machine as the destination for the communication with address information associated with the network appliance while preserving the first layer address information.
